(19) United States
(12) Patent Application Publication
(10) Pub. No.: US 2007/0297342 A1
(43) Pub. Date: Dec. 27, 2007

(54) Information processor with digital broadcast receiver

(75) Inventor: Hiroyuki Yasuta, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/812,617

(22) Filed: Jun. 20, 2007

(30) Foreign Application Priority Data
Jun. 23, 2006 (JP) 2006-174238

(51) Int. Cl. H04L 12/26

(52) U.S. Cl. 370/252; 370/486

(57) ABSTRACT

According to one embodiment, an information processor comprises an error detection circuit having at least one of a synchronous byte interval detection circuit, a synchronous byte comparison circuit and an error indication comparison circuit which receives digital information, transmitted as packet data, by a digital tuner unit and detects packet data having defects as an error in the sequentially received packet data from intervals of synchronous bytes, values of the synchronous bytes or values of error indications, and mounts a digital broadcast receiver to reproduce information from the packet data from which the packet data having the defects have been removed.

### CROSS-REFERENCE TO RELATED APPLICATIONS

This application is based upon and claims the benefit of priority from Japanese Patent Application No. 2006-174238, filed Jun. 23, 2006, the entire contents of which are incorporated herein by reference.

### BACKGROUND

1. Field

One embodiment of the present invention relates to an information processor with a digital broadcast receiver which receives a packet to be used in a digital broadcast and a digital communication.

2. Description of the Related Art

In a television broadcast, a change from an analog broadcast to a digital broadcast, inclusive of a terrestrial digital broadcast which has been developed in recent years, has been made in order to improve an image quality and to increase in an information quantity. As to the digital broadcast, for example, an orthogonal frequency division multiplexing (OFDM) system has been used. This OFDM system has a feature in a link transmission by means of a hierarchical transmission and a narrow band broadcast, assigns different information, such as data, voice and image, to three-hierarchy transport streams (TSs), respectively, and multiplexes the TSs as a single TS packet to transmit/receive it. In a transmission using such a TS packet, in the case in which, for example, a failure occurs on a transmission path, a situation, such that a TS in a specific hierarchy cannot be used as information, occurs. To prevent the occurrence of the situation, the digital broadcast practically inserts a null packet consisting of empty data to fix an output clock in a receiver. This null packet having no data originally, the decoding of the null packet results in unnecessary processing.

In contrast, Jpn. Pat. Appln. KOKAI Publication No. 2003-273824 proposes a technique to decrease a processing quantity by outputting no null packet to save the power of a receiver and to achieve a reduction in recording data. That is, the technique configures the receiver so as to dispose an output instructing unit and a hierarchy selecting unit in a latter stage of an error correcting unit. The hierarchy selecting unit selects only TS packets in hierarchies with efficiency of outputs form the output instructing unit supported therein among a plurality of TSs multiplexed into the TS packets to output the TS packets to a circuit in the latter stage. Thereby, the latter stage does not perform any processing unnecessary to the null packets and there is no need to store the TS packets including the null packets therein.

However, the digital broadcast receiver to receive the digital broadcast detects the TS packet of, for example, 204-byte as an error if the TS packet is received along the way at the timing to operate a change operation of channels. Therefore, a conventional device configuration, including one which has been disclosed by Jpn. Pat. Appln. KOKAI Publication 2003-273824, writes in the TS packet with the error output from a digital tuner unit in a main memory once. Thereby, television reproduction program processing by means of a processor (CPU) increases in processing quantity to be a burden on the CPU because the program processing error detection processing of the TS packets in addition to decoding processing, separation processing and decoding processing of MPG2-TS. Accordingly, with regard to a CPU, a CPU having further high-performance is required.

More specifically, not only a conventional exclusive television receiver, but also a digital broadcast receiver is desired to reduce the burden on the CPU because the digital broadcast receiver is mounted on an information processor, such as a personal computer and a personal digital assistance (PDA), as a function unit, and when a processing burden to the CPU becomes heavy, it results in affecting to other processing performance.

### BRIEF SUMMARY

An embodiment according to the invention is an information processor with a digital broadcast receiver to reduce a processing burden on a control unit.

The embodiment provides an information processor, comprising a digital tuner unit which receives a digital broadcast by which information comprises data, voices and images are transmitted as packet data, a control unit which includes an error detection circuit to detect packet data having a defect in the packet data output from the digital tuner unit and transmits packet data, from which the packet data having the defect error-detected by the error detection circuit is removed, to a bus, and an information processing unit which reproduces the information from the packet data, which is output from the tuner unit to the bus, and from which the packet data having the defect is removed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a schematic configuration of a digital broadcast receiver regarding an embodiment of the invention;

FIG. 2 is an exemplary view depicting a structure of a packet and a stream of an MPEG2-TS;

FIG. 3 is an exemplary block diagram depicting a concrete configuration example of a control unit having a content protection function of the embodiment;

FIG. 4 is an exemplary timing chart for explaining operation timing of the inside of the control unit having the content protection function of the embodiment;

FIG. 5 is an exemplary view depicting a circuit diagram of a synchronous bite interval detection circuit 21 depicted in FIG. 3;

FIG. 6 is an exemplary view depicting a synchronous byte comparison circuit depicted in FIG. 3; and

FIG. 7 is an exemplary view depicting an error indication comparison circuit depicted in FIG. 3.

### DETAILED DESCRIPTION

Various embodiments according to the invention will be described hereinafter with reference to the accompanying drawings. In general, according to one embodiment of the invention, an information processor comprising: a digital tuner unit which receives a digital broadcast by which information having data, voices and images are transmitted as packet data; a control unit which includes an error detection circuit to detect packet data having a defect in the packet data output from the digital tuner unit and transmits packet data, from which the packet data having the defect error-detected by the error detection circuit is removed, to a bus; and an information processing unit which reproduces the information, by using a television reproduction program, from the packet data, which is output from the digital tuner unit to the bus, and from which the packet data having the defect is removed.

Hereinafter, embodiments of the invention will be described in detail with reference to the drawings.

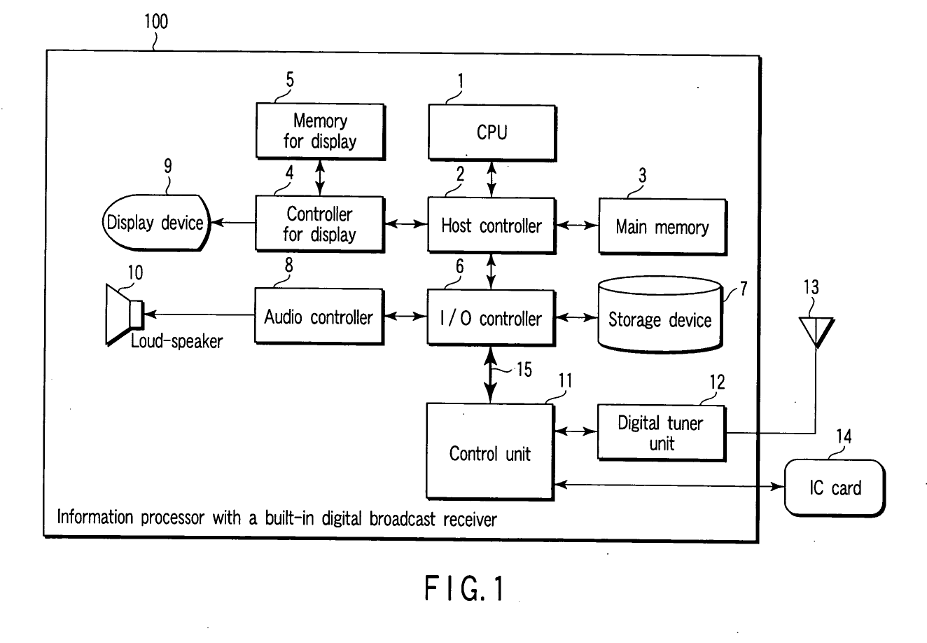

FIG. 1 is a block diagram illustrating a schematic configuration of an information processor with a built-in digital broadcast receiver (hereinafter, referred to as information processor) regarding an embodiment of the invention.

An information processor 100 is mounted on a personal computer (PC) corresponding to a reception of a digital broadcast and comprises a central processing unit (CPU) 1, a host controller 2, a main memory 3, a display controller 4, a display memory 5, an input/output (I/O) controller 6, a storage device 7, an audio controller 8, a control unit 11 having a content protection function, a digital tuner unit 12, and the like. As to constituent components shown in FIG. 1, only constituent components regarding the outline of the embodiment are typically shown therein, constituent components, such as input devices (for example, keyboard, etc.), disposed at a generic information processor, are supposed to be obviously included, and they are omitted to be illustrated.

In such a configuration, the CPU 1 is a processor which is disposed in order to control the whole of the information processor 100, and carries out a variety of information processing and calculation on the basis of an operating system (OS) and various kinds of programs loaded from the storage device 7 to the main memory 3. In the embodiment, the information processor 100 performs processing operations by means of a television reproduction program which is pre-installed as one of the programs and reproduces the received broadcast data.

The host controller 2 functions as a bridge to transmit and receive a signal (information) through a local bus and the I/O controller 6 of the CPU 1. The host controller 2 has a memory controller to control access from the main memory 3 built-in. The display controller 4 controls display operations at a display device 9. The display memory 5 is connected to the display controller 4, and image data read out from the display memory 5 is displayed on the display device 9 in accordance with the OS and the programs. Writing in image data is also performed in accordance with the control by the television reproduction program.

The I/O controller 6 has a controller so as to control the storage device 7 built-in. The I/O controller 6 also carries out control of each device connected through a bus 15. The audio controller 8 converts the audio data (PCM, etc.) transmitted from the OS and the program into electric signals, and drives a loud-speaker 10 to reproduce voices.

The digital tuner unit 12 is a device to receive broadcast data, such as television program of the digital broadcast, and receives the broadcast data of a channel number specified by a command from the television reproduction program. A television antenna 13 is connected to the digital tuner unit 12. The digital tuner unit 12 demodulates the broadcast data received by the television antenna 13, and generates transport stream packets in, for example, MPEG2-TS formats (hereinafter, referred to as TS packets).

The control unit 11 inputs the TS packets output from the digital tuner unit 12, performs decoding processing of the TS packets by using key information read out from an IC card 14, applies filtering processing to unnecessary TS packets, then, carries out encryption processing again to write them in the main memory 3. At this moment, the control unit 11 detects defective packets (data) having errors, removes them by using the below mentioned error detection circuit 20 then encrypts only the proper data again, and transmits it to the main memory 3 of the information processing unit through the bus 15. Here, the information processing unit suggests the CPU 1, the host controller 2, the main memory 3, the I/O (input/output) controller 6, the storage device 7, or the like. Further, the digital broadcast receiver is composed mainly of the control unit 11, the digital tuner unit 12, and the television antenna 13. The display controller 4, the display memory 5, the audio controller 8, the display device 9, and the loud-speaker 10 are referred to as an output drive unit.

The television reproduction program decrypts the encrypted TS packets which are written in the main memory 3 and separates them into additional information, such as an image, a voice and a data broadcast. If the additional information is the image, the television reproduction program decodes the separated image data to generate display image data, and writes it in the display memory 5. If the additional information is the voice, the television reproduction program decodes the separated voice data to generate reproduction voice data, and transmits it to the audio controller 8. If the additional information is the data of a data broadcast, the television reproduction program analyzes the data to generate display data, and writes it in the display memory 5.

The digital broadcast receiver of the embodiment uses the CPU mounted on the information device, such as a PC to carry out the processing of the MPEG2-TS through software. Hereinafter, the MPEG2-TS will be described briefly.

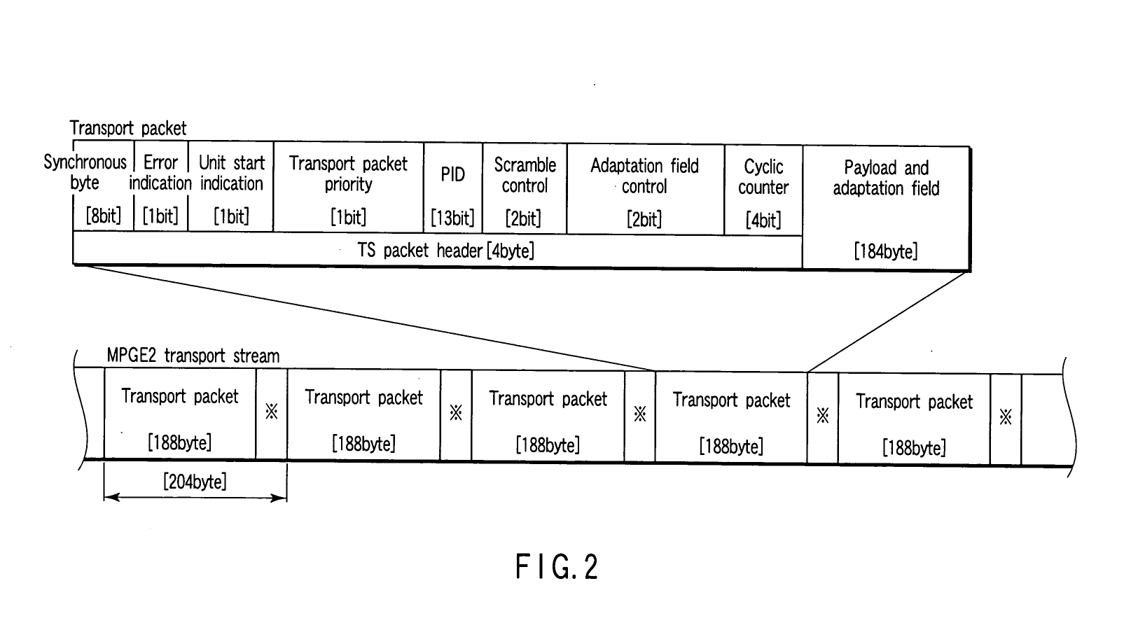

FIG. 2 illustrates structures of the packet and the stream of the MPEG2-TS.

The TS packet is data of 188-byte fixed length, the head 4-byte (32-bit) is a TS packet header, and the remaining 184-byte is a payload and an adaptation field. The TS packet header has a well known structure composed of a synchronous byte (8-bit, data is 0×47) designating the head of the packet, an error indication (1-bit) designating the presence or absence of a bit error in the packet, packet ID (PID) (13-bit) that is identification information of the packet, etc. Further, in the digital broadcast, error correction data of 16-byte (illustrated by symbol [symbol] ) following the TS packet being added, total 204-byte (188-byte+16-byte) is processed as one packet.

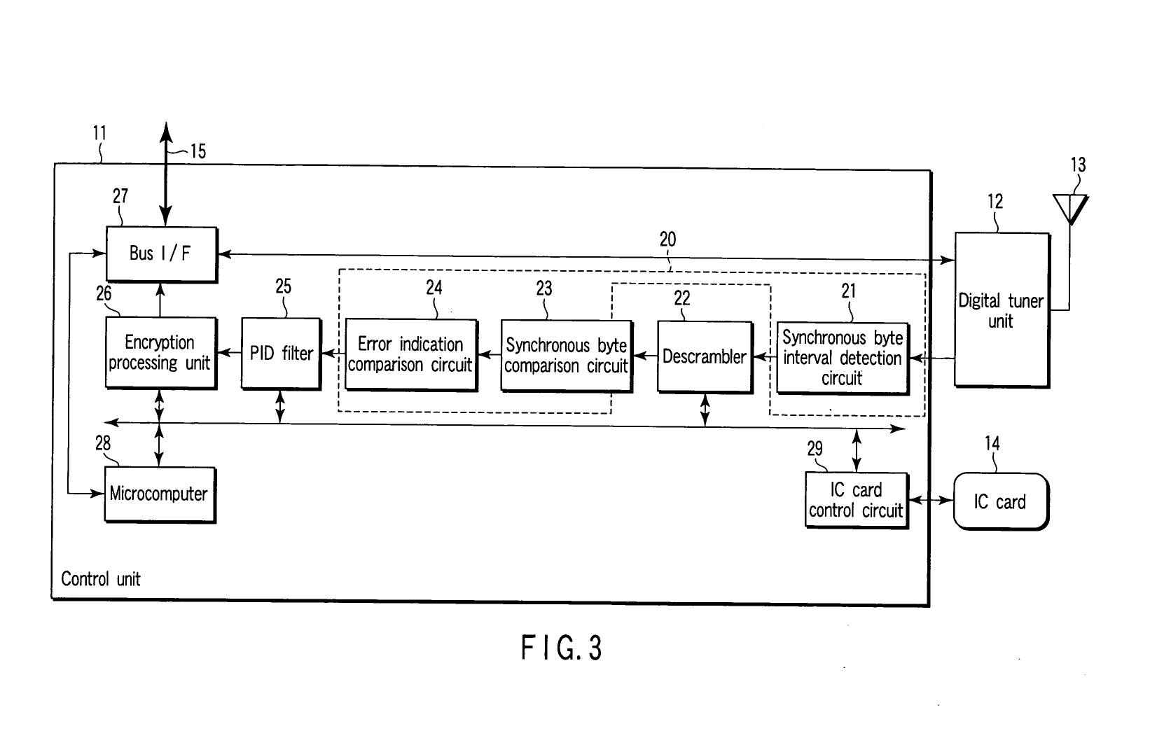

Next to this, FIG. 3 is a block diagram illustrating a concrete configuration of the control unit 11 of the embodiment.

The control unit 11 comprises an error detection circuit 20 of the TS packets, a descrambler (decryption processing unit) 22 to decrypt the encrypted TS packets, a PID filter 25 to perform authentication by the identification information of the TS packets, an encryption processing unit 26, a bus I/F 27, and a microcomputer 28 to control information processing, and each constituent component, and an IC card control circuit 29 to perform authentication through a detachable authentication card, such as an IC card owned by the user.

The error detection circuit 20 of the TS packets is composed of the below mentioned synchronous byte interval detection circuit 21, a synchronous byte comparison circuit 23, and an error indication comparison circuit 24. The error detection circuit 20 firstly detects errors to the packets which have not been set by prescribed intervals from the intervals of the synchronous bite of the MPEG2-TS packets by using the synchronous bite interval detection circuit 21. Secondary, the error detection circuit 20 detects errors from the values of the synchronous bite of the MPEG2-TS packets by using the synchronous bite interval detection circuit 23. Thirdly, the error detection circuit 20 detects errors from the values of the error indication in the MPEG2-TS packets by using the error indication comparison circuit 24.

The control unit 11 operates on the basis of the clock signal output from the digital tuner unit 12, inputs data4 (DATA4) and a valid signal VALID4, and outputs data5 (DATA5) and a valid signal5. The data 5 is a TS packet which has been applied filtering processing. The PID filter 25 performs comparison processing of the PIDs in the input TS packets to apply filtering processing of unnecessary TS packets. If the data5 is valid data, the valid signal VALID5 becomes “1”, and if it is invalid data, the valid signal VALID5 becomes “0”. The microcomputer 28 sets the PIDs, and it sets, for example, 0×1 FFF (null packet or packet unnecessary in processing).

The encryption processing unit 26 inputs the data 5 and the valid signal VALID5 output from the PID filter 25, and outputs data6 (DATA6) and a valid signal VALID6. The microcomputer 28 sets operation conditions of the encryption processing unit 26. Here, the data6 is the TS packet to which the encryption processing has been applied. If the DATA6 is valid, and if it is invalid, the output signal VALID6 becomes “1” and “0”, respectively.

The bus I/F 27 is a circuit which conducts control in order to output the data6 output from the encryption processing unit 26 to the bus I/F. The bus I/F 27 converts the data6 into data with timing appropriate to the bus I/F and outputs it to the bus 15. The output data is written in the main memory 3. Other than this the bus I/F 27 also carries out the processing to send a channel setting command transmitted from the program reproduction program to the digital tuner unit 12, and carries out operation setting of the micro computer 28.

The microcomputer 28 conducts processing of key data form the IC card 14, and conducts operation setting of the descrambler 22, the PID filter 25 and the encryption processing unit 26. The IC card control circuit 29 carries out the processing to transmit the IC card control command transmitted from the microcomputer 28 to the IC card, and carries out the processing to transmit the data received from the IC card to the microcomputer 28.

Disposing the error detection circuit 20 of the TS packets in the control unit 11 omits or simplifies the TS packet error detection processing which has been performed conventionally by the reproduction program then the processing quantity to be carried out by the CPU 1 may be reduced. Further, suppressing the output of the TS packets unnecessary in processing (or, impossible to be processed) enables decreasing in a memory use quantity and a recording data size.

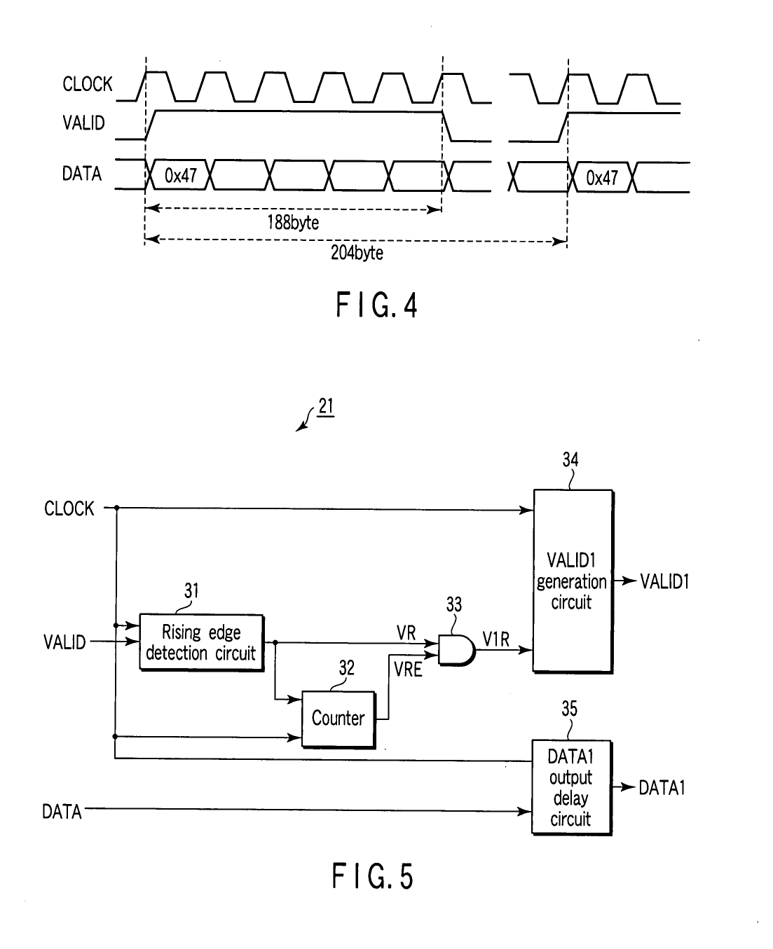

With reference to the timing chart shown in FIG. 4, operation timing inside the content protection control unit will be described.

A clock signal (CLOCK) is one to become a reference for the operation timing output from the digital tuner unit 12, and it becomes the reference of the operation timing of the control unit 11. When the data (DATA) is valid, the valid signal VALID is a control signal indicating “1”, and when it is invalid, the valid signal VALID is a control signal indicating “0”. The control signals are output from the digital tuner unit 12 in synchronization with the rising edge of the clock signal.

The data is the TS packet, and output from the digital tuner unit 12 in synchronization with the rising edge of the clock signal. When the digital tuner unit 12 outputs a normal TS packet, the data head of the TS packet is the synchronous bite (0×), and the next synchronous byte (0×) is output at 204th and succeeding cycles. However, depending on data, the next synchronous bite (0×47) is output at exactly 204th sometimes, and it is output at the succeeding cycles sometimes.

Here, when the digital tuner unit 12 outputs an abnormal TS packet, the content protection control unit is brought into a state, such that the next synchronous bite is output before the 204th cycle, or the value of error indication of the header of the TS packet indicates “1” (indicates existence of error in output TS packet).

Next, FIG. 5 illustrates a circuit diagram of the synchronous bite interval detection circuit 21.

The interval detection circuit 21 have a rising edge detection circuit 31 which detects the rising edge of the valid signal that is the clock signal and the input signal, a counter 32 which operates by the clock signal and the output from the rising edge detection circuit 31, an AND circuit 33 which produces the product (AND) of the below mentioned VR signal and the counter output, a VALID1 generation circuit 34 which generates a VALID signal 1, and a DATA1 output delay circuit 35.

The interval detection circuit 21 operates on the basis of the clock signal output from the digital tuner unit 12, inputs the data and the valid signal output from the digital tuner unit 12, and outputs the data 1 and the Valid signal VALID1. The rising edge detection circuit 31 is a circuit to detect the rising edge of the input valid signal. When the rising edge detection circuit 31 detects the rising edge of the input valid signal, the VR signal becomes “1” only in one cycle, and it becomes “0” in the other cycles.

The counter 32 detects the intervals of the synchronous bytes between TS packets. The counter 32 starts the count by detecting the rising edge of the VR signal, and when it counts up to “203” then it clears the count value to “0” to stop its operation.

If the counter 32 is in operation, or in suspend, it outputs “0” or “1”, respectively. The VALID1 generation circuit 34 is a control circuit of the output VALID signal VALID1. The VALID signal VALID1 which is output from the VALID1 generation circuit 34 outputs “1” when the counter detects the rising edge of a V1R signal.

In the case of the embodiment, the VALID signal VALID1 is output after one cycle of the VALID signal VALID. The V1R signal is a signal of the product (AND) of the VR signal output from the rising edge detection circuit 31 and the VER signal output from the counter 33. If the counter 32 is in operation, or in suspend, the V1R signal becomes “0” or the VR value, respectively.

The DATA1 output delay circuit 35 is a circuit which synchronizes the output timing of the output data1 with the VALID signal VALID1. In the circuit of the embodiment, the data1 is output after one cycle of the data signal.

Next to this, the descrambler 22 performs decoding processing (decryption processing) of the TS packet encrypted using the key information from the IC card 14. The descrambler 22 operates on the basis of the clock signal output from the digital tuner unit 12, and inputs the data1 and the VALID signal VALID1 output from the synchronous bite interval detection circuit 21. The data2 (DATA2) is the TS packet to which the decoding processing has been applied. If the data2 is valid, or invalid, the valid signal VALID2 outputs “1” or “0”, respectively. The microcomputer 28 conducts operation setting for the digital broadcast receiver.

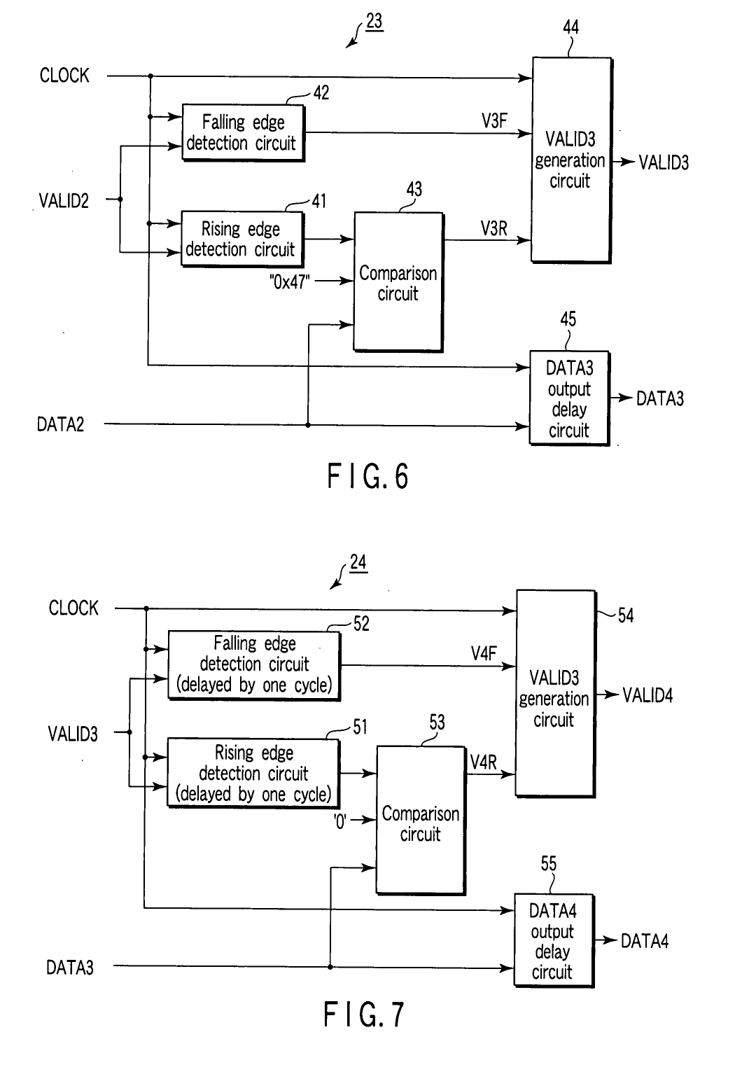

FIG. 6 illustrates the circuit diagram of the synchronous bite comparison circuit 23.

The synchronous byte comparison circuit 23 have a rising edge detection circuit 41, a falling edge detection circuit 42, a comparison circuit 43, a VALID3 generation circuit 44, and a DATA3 output delay circuit 45. The falling edge detection circuit 42 is not always necessary.

The digital tuner unit 12 outputs a clock signal. The synchronous bite comparison circuit 23 inputs the data2 (DATA2) output from the descrambler 22 and VALID signal VALID2 to output data3 (DATA3) and a VALID signal VALID3, based on the timing of the clock signal.

The rising edge detection circuit 41 is a circuit to detect the rising edge of the VALID signal VALID2. When detecting the rising edge, the V2R signal becomes “1” only for one cycle period, and it becomes “0” for the other periods. The falling edge detection circuit 42 is a circuit to detect the falling edge of the VALID signal VALID2. When detecting the falling edge, the V2F signal becomes only for one cycle period, and it becomes “0” for the other periods.

The comparison circuit 43 is a comparison circuit of the synchronous bytes of the TS packets. In the case of “1” of the input V2R signal, the comparison circuit 43 carries out comparison processing between the data2 (DATA2) and a fixed value 0×47. If the comparison results are in agreement (if the data2 is 0×47), or if they are not in agreement (if the data2 is not 0×47), a V3R signal becomes “1” or “0”, respectively.

The VALID generation circuit 44 is a control circuit of the VALID signal VALID3. When detecting the rising edge of the input V3R signal, or when detecting the falling edge of the V3F signal, the VALID3 generation circuit 44 outputs the VALID signal VALID3 “1” or VALID signal VALID3 “0”, respectively. In this embodiment, the VALID signal VALID3 is output after one cycle of the valid signal VALID2. Furthermore, The DATA3 output delay circuit 45 is a circuit to synchronize the output timing of the data3 (DATA3) to be output with the valid signal VALID3, and to output the data3 after one cycle of the data2.

FIG. 7 show a circuit diagram of the error indication comparison circuit 24.

The error indication comparison circuit 24 is composed of a rising edge detection circuit 51, a falling edge detection circuit 52, a comparison circuit 53, a VALID4 generation circuit 54, and a DATA4 output delay circuit 55. The error indication comparison circuit 24 operates on the basis of the clock signal output from the digital tuner unit 12, inputs the data3 (DATA3) and the valid signal VALID3 output from the synchronous byte comparison circuit 23, and outputs data4 (DATA4).

The rising edge detection circuit 51 is a circuit to detect the rising edge of the input valid signal VALID3. When the rising edge is detected, the V3R signal to be output becomes “1” only for one cycle period, and it becomes “0” for other cycles. The V3R signal is delayed by one cycle and output because the error indication exists at the second byte of the TS packet.

The falling edge detection circuit 52 is a circuit to detect the falling edge of the input signal VALID3. The V3F signal becomes “1” only at one cycle when the falling edge detection circuit 52 detects the falling edge, and it becomes “0” at other cycles. The V3F signal is output with a delay by one cycle because the error indication exists at the second byte of the TS packet.

The comparison circuit 53 is a comparison circuit of error indications of the TS packets and conducts comparison processing between the data3 and the fixed value “0” in the case that the V3R signal is “1”. When the comparison results coincide with each other (when the error indication of the input data3 is “0”), a V4R signal becomes “1”, and when the results do not coincide with each other (when the error indication of the input data 3 is “1”), the V4R signal becomes “0”. When the rising edge of the V4R signal is detected as the valid signal VALID4, the VALID3 generation circuit 54 outputs “1”, and when the rising edge of the V4F signal, it outputs “0”.

In the configuration of the embodiment, the valid signal VALID4 is output after 2 cycles of the valid signal VALID3. The DATA4 output delay circuit 55 is a circuit to synchronize the output timing of the data4 (DATA4) with the valid signal VALID4, and outputs the data4 after 2 cycles of the data3.

As described above, the embodiment is configured to perform the error detection of the TS packet by means of a circuit (hardware), and extremely reduces the burden of the processing on the CPU for the error detection in comparison to the error detection through program processing. More specifically, when the digital broadcast receiver in the embodiment is mounted on an information processor, such as a personal computer and a PDA, the burden of the error detection processing on the CPU of the information processor may be decreased.

The embodiment may reduce the information processing quantity and the memory use quantity for the CPU and may further make the recording data size smaller by disposing the error detection circuit of the TS packet consisting of hardware. Therefore, if it is enough for the information processor to be the same in performance, the CPU with performance lower than at present may be employed, and may achieve a reduction in a cost of the memory quantity by lowering its capacity. In the current information processor may still have information processing quantity and memory use quantity for the CPU, and may mount the processing for other information and may mount other functions.

A television receiver or the like corresponding to a reception of the digital broadcast carries out the processing of MPEG2-TS by mounting an exclusive circuit; however, the digital broadcast receiver may attain the processing of the MPEG2-TS through the software with a low burden, an exclusive circuit is not required, and may suppress a mounting cost.

An embodiment according to invention, an information processor with the digital broadcast receiver which reduces the processing burden on the control unit may be provided.

Disposing the error detection circuit for the TS packet of the MPEG2-TS in the digital broadcast processor may eliminate or simplify the error detection processing of the MPEG2-TS packet which has been carried out by the CPU through the television reproducing program to decrease the information processing quantity and the memory use quantity to the CPU, and may make the recording data size further smaller.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a digital tuner unit which receives a digital broadcast by which information having data, voices and images are transmitted as packet data;
a control unit which includes an error detection circuit to detect packet data having a defect in the packet data output from the digital tuner unit and transmits packet data, from which the packet data having the defect error-detected by the error detection circuit is removed, to a bus; and
an information processing unit which reproduces the information, by using a television reproduction program, from the packet data, which is output from the digital tuner unit to the bus, and from which the packet data having the defect is removed.

2. The processor according to claim 1, wherein the control unit comprises:
an decryption processing unit to decrypt encrypted packet data output from the digital tuner unit; and an encryption processing unit to encrypt again the packet data from which the packet data with the defect is removed by the error detection circuit and to transmit the packet data to the bus.

3. The processor according to claim 1, wherein the control unit comprises a packet ID filter unit to perform identification information authentication by comparison processing of packet IDs to the packet data input to the encryption processing unit and to apply filter-processing to unnecessary packet data.

4. The processor according to claim 1, wherein the control unit comprises an authentication unit to limit use by means of a detachable authentication card.

5. The processor according to claim 1, wherein the error detection circuit comprises a synchronous byte interval detection circuit which detects intervals of packet synchronous byte set in a header of the packet data to detect intervals of packet synchronous byte, and detects the packet data having an interval shorter than a prescribed interval as an error.

6. The processor according to claim 1, wherein
the error detection circuit comprises a synchronous byte comparison circuit which compares a value of a packet synchronous byte set at a header of the packet data to a prescribed reference value, and detects the packet data as an error when they are not coincident with each other.

7. The processor according to claim 1, wherein
the error detection circuit comprises an error indication comparison circuit which compares a value of a packet error display set in a header of the packet data to a prescribed reference value, and detects as an error when they are not coincident with each other.

8. The processor according to claim 1, wherein the information comprises the data, voices and images generated from the digital tuner unit has a data structure of the transport stream of an MPEG2.

9. An information processing method comprising:
receiving a digital broadcast to be encrypted to generate information comprises data, voices and images as packet data;
removing packet data having defects in a front stage and a rear stage of decryption by using an error detection circuit to the packet data;
performing re-encryption the packet data to propagate to a bus; and
reproducing the information by a television reproduction program through an information processing unit.

10. The method according to claim 9, further comprising:
authenticating identification information by comparison processing of packet IDs to the packet data before the re-encryption to apply filter-processing to unnecessary packet data.

11. The method according to claim 9, further comprising:
authenticating information processing before error processing by the error detection circuit.

12. The method according to claim 9, wherein
the error detection by the error detection circuit performs first error detection to detect intervals of packet synchronous bytes set in headers in the packet data, and to detect the packet data having an interval shorter than a prescribed interval as an error.

13. The method according to claim 9, wherein the error detection by the error detection circuit performs second error detection to compare values of the packet synchronous bytes set in headers of the packet data to a prescribed reference value, and to detect as an error when they are not coincide with one another.

14. The method according to claim 9, wherein the error detection by the error detection circuit performs third error detection to compare a value of a packet error display set in headers of the packet data to a prescribed reference value, and to detect as an error when they are not coincident with each other.

15. The method according to claim 9, wherein the information comprises the data, voices and images has a data structure of a transport stream of an MPEG2.
